(19) United States
(12) Patent Application Publication
(10) Pub. No.: US 2015/0012863 A1
(43) Pub. Date: Jan. 8, 2015

(54) CONTROL METHOD

(71) Applicant: Panasonic Intellectual Property Corporation of America, Torrance, CA (US)

(72) Inventors: Chikara Yoshida, Kanagawa (JP); Masayuki Kozuka, Osaka (JP); Toshihisa Nakano, Osaka (JP); Tsutomu Sekibe, Osaka (JP); Jun Yamaguchi, Osaka (JP); Kazushige Yamada, Osaka (JP); Kenji Shimizu, Kanagawa (JP); Masaki Takahashi, Osaka (JP); Yuri Nishikawa, Osaka (JP); Motoji Ohmori, Osaka (JP); Hiroyuki Takemura, Osaka (JP); Takeshi Hosaka, Osaka (JP)

(73) Assignee: Panasonic Intellectual Property Corporation of America, Torrance, CA (US)

(21) Appl. No.: 14/378,195

(22) PCT Filed: Dec. 25, 2013
(86) PCT No.: PCT/JP2013/007594

§ 371 Date: Aug. 12, 2014

Related U.S. Application Data
(60) Provisional application No. 61/746,662, filed on Dec. 28, 2012.

(51) Int. Cl. G06F 3/0482; G06F 3/0481; H04L 29/06; G06F 3/0484

(52) U.S. Cl. CPC G06F 3/0482; G06F 3/04842; G06F 3/04817; H04L 63/126
USPC 715/771

(57) ABSTRACT

A control method is used in a remote control system including apparatuses and an information terminal that controls the apparatus(es) via a network. The control method includes: determining whether or not communication currently performed by the information terminal via the network is secure; displaying, for each apparatus, an icon for displaying control menus of a corresponding apparatus on a user interface region of a display unit in the information terminal in a display mode determined according to the determined security; displaying, on the user interface region, the control menus for controlling the corresponding apparatus, if the icon is selected; generating a control signal for causing the corresponding apparatus to perform an operation according to control corresponding to a first control menu, if the first control menu s selected from the displayed control menus; and transmitting the control signal to the corresponding apparatus via the network.

### TECHNICAL FIELD

The present invention relates to control methods used in remote control systems.

### BACKGROUND ART

In recent years, with the development of network environments in home, not only information apparatuses, such as personal computers, but also home appliances, such as television sets (TVs), video recorders, air conditioners, and refrigerators, have been getting connected to a network. The network connection provides various types of usability to users. For example, users can control home appliances via a network.

For example, Patent Literature 1 (PTL 1) discloses a technique relating to an integrated controller capable of appropriately controlling apparatuses including home appliances.

### CITATION LIST

### Patent Literature

[PTL 1] Japanese Unexamined Patent Application Publication No. 2003-111157

### SUMMARY OF INVENTION

### Technical Problem

However, the conventional technologies as disclosed in PTL 1 have problems. For example, users are allowed to control home appliances having a heating function even from the outside of home.

In order to address the above problems, an object of the present invention is to provide a control method of appropriately controlling a target apparatus according to a situation of the target apparatus by using an information terminal.

### Solution to Problem

In accordance with an aspect of the present invention for achieving the object, there is provided a control method used in a remote control system including a plurality of apparatuses and an information terminal that controls at least one of the apparatuses via a network, the control method including: determining whether or not communication currently performed by the information terminal via the network is secure; displaying, for each of the apparatuses, an icon for displaying one or more control menus corresponding to a corresponding apparatus of the apparatuses, on a user interface region of a display unit in the information terminal in a display mode determined according to the security of the communication determined in the determining; displaying, on the user interface region in the information terminal, the one or more control menus for controlling the corresponding apparatus, if the icon is selected; generating a control signal for causing the corresponding apparatus to perform an operation according to control corresponding to a first control menu, if the first control menu is selected from the one or more control menus displayed on the information terminal; and transmitting the control signal to the corresponding apparatus via the network.

These general and specific aspects may be implemented to a system, a method, an integrated circuit, a computer program, and a computer-readable recording medium, such as a Compact Disc-Read Only Memory (CD-ROM), and may be implemented also to a desired combination of them.

### Advantageous Effects of Invention

The control method according to the present invention is capable of appropriately control target apparatuses according to security of communication performed in an information terminal.

### BRIEF DESCRIPTION OF DRAWINGS

FIG. 1 is a diagram illustrating an example of an overall configuration of a remote control system according to Embodiment.

FIG. 2 is a block diagram illustrating an example of a structure of an information terminal according to Embodiment.

FIG. 3 is a block diagram illustrating an example of a structure of a server according to Embodiment.

FIG. 4 is a flowchart of processing performed in the remote control system according to Embodiment.

FIG. 5 is a flowchart of communication check processing performed in the remote control system according to Embodiment.

FIG. 6 is a diagram illustrating an example of an operation screen of the information terminal in the remote control system according to Embodiment.

FIG. 7 is a diagram illustrating an example of an operation screen of the information terminal in the remote control system according to Embodiment.

FIG. 8 is a table of operation conditions in operating apparatuses by a remote control application registered in a database (DB) according to Embodiment.

FIG. 9 is a time chart of an example of processing performed in the remote control system according to Example of Embodiment.

FIG. 10 is a diagram illustrating an example of a Graphical User Interface (GUI) on a display screen of a smartphone according to Example of Embodiment.

FIG. 11 is a table indicating details of information to be transmitted from the remote control application to the server according to Example of Embodiment.

FIG. 12 is an example of a user information table registered in the DB in the server according to Example of Embodiment.

FIG. 13 is an example of a user information table registered in the DB in the server according to Example of Embodiment.

FIG. 14A is a diagram illustrating an example of a display screen of a smartphone according to Example of Embodiment.

FIG. 14B is a diagram illustrating an example of a display screen of a smartphone according to Example of Embodiment.

### DESCRIPTION OF EMBODIMENT

### Observation based on which Present Invention is Conceived

However, the conventional technologies as disclosed in PTL 1 have problems. For example, users are allowed to control home appliances having a heating function even from the outside of home.

More specifically, if one of home appliances is to be controlled (hereinafter, such a home appliance is referred to also as a “target apparatus”), controllable items (control menus) of providable functions of the target apparatus vary depending on various situations, for example, depending on an “operator (who)”, a “time of operation (when)”, a “place for operation (at where)”, the “apparatus to be operated (what)”, and a “place where the apparatus is set (to where)”. Furthermore, it would be necessary to suppress certain control on apparatuses depending on situations in terms of operability, security, privacy, cost (electricity cost or the like), or noise and vibration (troubles to the others). For example, if a target apparatus is a home appliance having a heating function in home, it is necessary to prevent control on such an apparatus from the outside of home.

In order to address the above problem, an object of the present invention is to provide a control method of appropriately controlling a target apparatus according to a situation of the target apparatus by using an information terminal.

In accordance with an aspect of the present invention for achieving the object, there is provided a control method used in a remote control system including a plurality of apparatuses and an information terminal that controls at least one of the apparatuses via a network, the control method including: determining whether or not communication currently performed by the information terminal via the network is secure; displaying, for each of the apparatuses, an icon for displaying one or more control menus corresponding to a corresponding apparatus of the apparatuses, on a user interface region of a display unit in the information terminal in a display mode determined according to the security of the communication determined in the determining; displaying, on the user interface region in the information terminal, the one or more control menus for controlling the corresponding apparatus, if the icon is selected; generating a control signal for causing the corresponding apparatus to perform an operation according to control corresponding to a first control menu, if the first control menu is selected from the one or more control menus displayed on the information terminal; and transmitting the control signal to the corresponding apparatus via the network.

By the method, it is possible to appropriately control a target apparatus according to security of communication performed by an information terminal.

For example, it is also possible that in the displaying of the icon, if the corresponding apparatus has a heating function, the display mode of the icon corresponding to the corresponding apparatus is determined according to whether the network connected to the information terminal is a first network or a second network that has a lower reliability than a reliability of the first network.

For example, it is further possible that in the displaying of the icon if the corresponding apparatus has a heating function and the network connected to the information terminal is the second network, the display mode of the icon corresponding to the corresponding apparatus is a display mode in which the icon is not selectable.

For example, it is still further possible that the first network is a paid network, and the second network is a free network.

For example, it is still further possible that in the displaying of the icon, if the corresponding apparatus has a heating function, the display mode of the icon corresponding to the corresponding apparatus is determined according to whether or not the communication currently performed by the information terminal is performed using a hardware security module.

For example, it is still further possible that in the displaying of the icon, if the corresponding apparatus has a heating function and the information terminal is performing the communication without using the hardware security module, the icon corresponding to the corresponding apparatus is displayed in the display mode in which the icon is not selectable.

For example, it is still further possible that the control method further includes determining whether or not an operator operating the information terminal is a predetermined operator who is registered, wherein in the displaying of the icon, if it is determined that the operator is the predetermined operator, the icon corresponding to the each of the apparatuses is displayed on the user interface region, and if it is determined that the operator is not the predetermined operator, an error display is displayed on the user interface region.

These general and specific aspects may be implemented to a system, a method, an integrated circuit, a computer program, and a computer-readable recording medium, such as a CD-ROM, and may be implemented also to a desired combination of them.

The following describes a control method used in a remote control system according to an Embodiment of the present invention with reference to the Drawings.

It should be noted that Embodiment described below is a specific example of the present invention. Numerical values, shapes, materials, constituent elements, arrangement positions and the connection configuration of the constituent elements, steps, the order of the steps, and the like described in the following Embodiment is merely an example, and is not intended to limit the present invention. Among the constituent elements in the following Embodiment, constituent elements that are not described in independent claims that show the most generic concept of the present invention are described as elements constituting more desirable configurations.

### Embodiment

### 1.1 Overall Configuration of Remote Control System

The following describes a remote control system 100 according to Embodiment with reference to the Drawings.

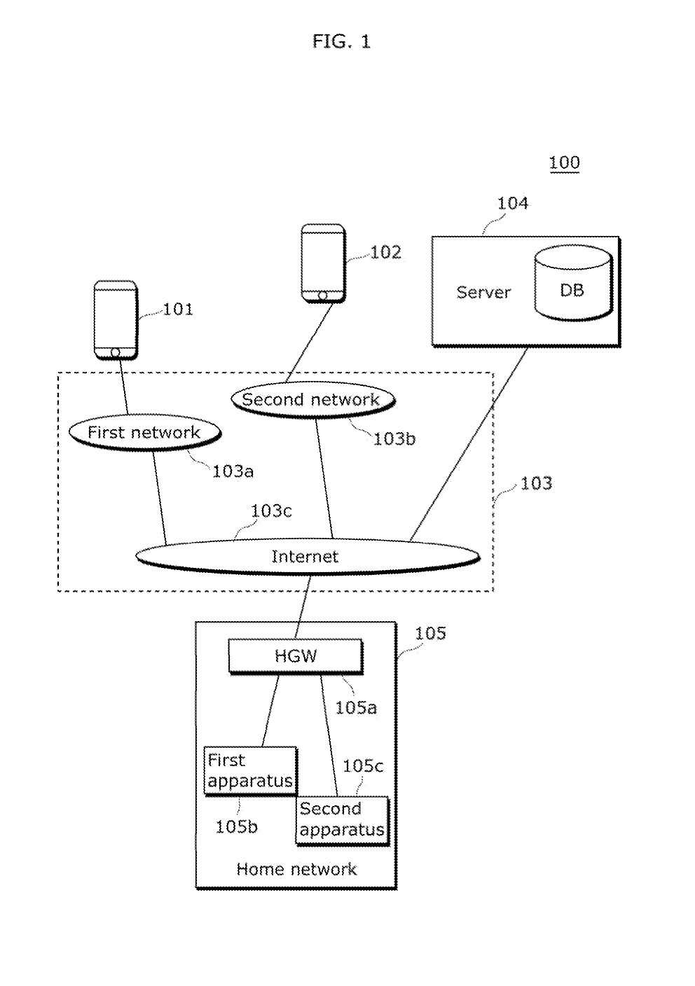

FIG. 1 is a diagram illustrating an example of an overall configuration of a remote control system according to Embodiment.

As illustrated in FIG. 1, the remote control system 100 includes information terminals 101 and 102 such as smartphones, a network 103, a server 104, and a home network 105. In the home network 105, for example, there are a Home Gate Way (HGW) 105a and a plurality of apparatuses (apparatuses to be controlled) such as a first apparatus 105b and a second apparatus 105c. An example of the first apparatus 105b is a kotatsu (Japanese heating apparatus). An example of the second apparatus 105c is a Blu-ray® Disc (BD) recorder. The apparatuses are communicable with the server 104 by connecting to the network 103 via the HGW 105a.

The HGW 105a has a function of notifying a processing request provided from the server 104 to a corresponding apparatus, and notifying the server 104 of information obtained from the apparatus, the result of the processing, and the like.

The network 103 includes the Internet 103c. Each of the information terminals 101 and 102 is connected, for example, to the Internet 103c via a first network 103a or a second network 103b included in the network 103. The first network 103a is, for example, a paid network, such as third generation (3G), Long Term Evolution (LTE), Worldwide Interoperability for Microwave Access (WiMAX), or Advanced eXtended Global Platform (AXGP). The second network 103b is, for example, a free network such as a public wireless Local Area Network (LAN).

### 1.2 Structure of Information Terminal

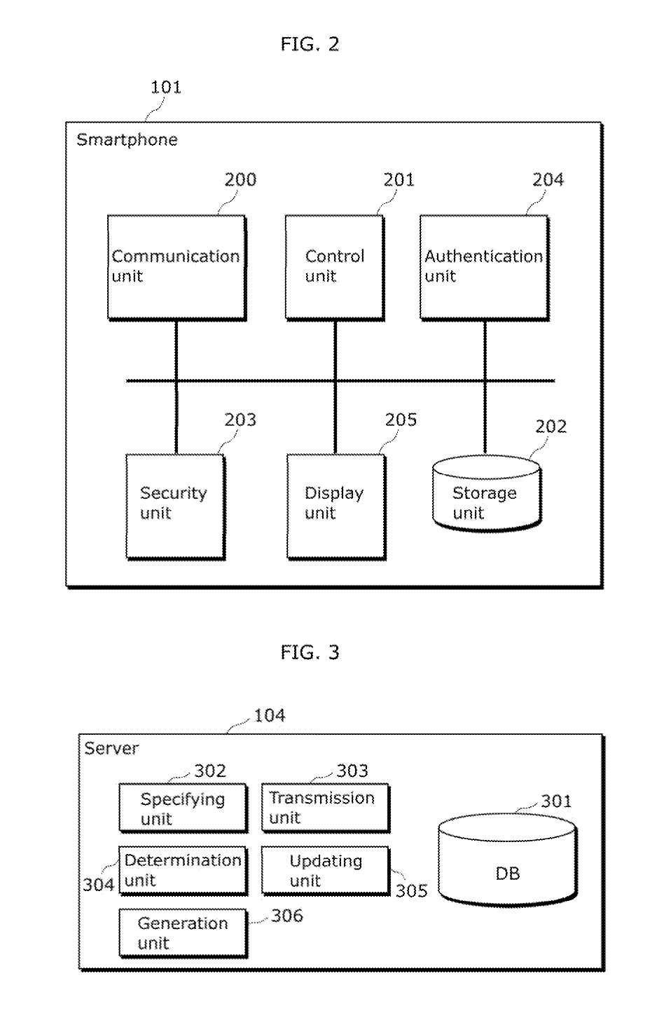

FIG. 2 is a block diagram illustrating an example of a structure of the information terminal according to Embodiment.

The information terminal 101 has a function of serving as a remote controller that issues a processing request to an apparatus to be controlled. The function of the information terminal 101 for serving as a remote controller is provided by executing a remote control application that is installed in the information terminal 101.

The following describes the above in more detail. As illustrated in FIG. 2, the information terminal 101 includes a communication unit 200, a control unit 201, a storage unit 202, a security unit 203, an authentication unit 204, and a display unit 205.

The communication unit 200 performs wireless communication with the network 103 by being connected with the first network 103a or the second network 103b.

The storage unit 202 stores a program of he remote control application.

The control unit 201 executes the program of the remote control application stored in the storage unit 202, thereby performing the remote control function of the information terminal 101.

Examples of the display unit 205 are a touch display and the like. The display unit 205 has a user interface region on which at least touch inputting is possible. The display unit 205 is controlled by the control unit 201. More specifically, on a display screen including the user interface region, the display unit 205 displays control menus, icons, or the like in a display mode determined by the control unit 201. Here, the icons are images representing the respective apparatuses. If an icon displayed as selectable is selected, the display screen is changed to display control menus for controlling the selected apparatus. In short, each of the icons is a user interface capable of receiving an input from the user.

The communication unit 200 transmits a control signal to a target apparatus via the network 103.

The security unit 203 stores an encryption key that is used for certification encryption, authentication, digital, signature, or the like, when communication is being performed by using the communication unit 200. The security unit 203 is, for example, a hardware security module such as a security chip.

The authentication unit 204 authenticates the user allowed to use the remote control application. The authentication unit 204 specifies a user operating the information terminal 101 by, for example, individual authentication such as fingerprint authentication and image recognition, or speaker authentication using voice. More specifically, the authentication unit 204 obtains, from the user, a user's fingerprint, a user's face image, or a user's voice, and check it against authentication data. In the authentication data, the user's fingerprint, the user's face image, or the user's voice have already been registered in association with a user ID. The authentication unit 204 thereby identifies the user by the associated user ID in the authentication data.

The control unit 201 determines whether or not the communication currently performed by the communication unit 200 of the information terminal 101 via the network 103 is secure. The control unit 201 causes the user interface region of the display unit 205 in the information terminal 101 to display icons of the apparatuses in a display mode determined according to the determined communication security, thereby displaying control menus corresponding to a target apparatus. If a first control menu is selected from the control menus displayed on the user interface region of the display unit 205 in the information terminal 101, the control unit 201 generates a control signal for causing the target apparatus to perform processing according to the control corresponding to the first control menu.

Here, for example, if the target apparatus has a heating function, the control unit 201 may determine the display mode of the icon of the target apparatus according to whether the network 103 connected to the information terminal 101 is the first network 103a or the second network 103b having a lower reliability than that of the first network 103a.

Furthermore, for example, if the target apparatus has a heating function and the network connected to the information terminal 101 is the second network 103b, the control unit 201 may cause the user interface region to display the icon of the target apparatus in a display mode in which the user cannot select the icon (hereinafter, referred to also as a “non-selectable display mode”).

For example, if the target apparatus has a heating function and the network 103 connected to the information terminal 101 is the second network 103b, the control unit 201 may cause the user interface region to display a dialog for prompting the user to confirm whether or not to switch the network 103 from the second network 103b to the first network 103a. In this case, when it is confirmed on the dialog displayed on the information terminal 101 that the network 103 connected to the information terminal is to be switched from the second network 103b to the first network 103a, the communication unit 200 may the second network 103b to the first network 103a.

For example, if the target apparatus has a heating function, the control unit 201 may determine the display mode of the icon of the target apparatus according to whether or not the communication currently performed by the information terminal 101 is performed by using a hardware security module.

For example, if the target apparatus has a heating function and the information terminal 101 is performing the communication without using the hardware security module, the control unit 201 may cause the user interface region to display the icon of the target apparatus in a non-selectable display mode.

In this case, for example, if the target apparatus has a heating function and the communication unit 200 of the information terminal 101 is performing the communication without using the security unit 203 (the hardware security module), the control unit 201 may cause the user interface region to display the icon of the target apparatus in a non-selectable display mode.

For example, the authentication unit 204 may determine whether or not an operator of the information terminal 101 is a predetermined operator who is registered. Then, if the authentication unit 204 determines that the operator is the predetermined operator, the control unit 201 may cause the user interface region of the display unit 205 to display a plurality of icons corresponding to the respective apparatuses. On the other hand, if the authentication unit 204 determines that the operator is not the predetermined operator, the control unit 201 may cause the user interface region of the display unit 205 to display an error display.

### 1.3 Structure of Server

FIG. 3 is a block diagram illustrating an example of a structure of the server according to Embodiment.

The server 104 receives a processing request from the information terminal 101, for example, and performs processing requested in the processing request. In addition, the server 104 performs processing for inquiring the HGW 105a about information necessary to perform the requested processing. The server 104 notifies the processing request to a target apparatus via the HGW 105a.

The server 104 include a database (DB) 301, a specifying unit 302, a transmission unit 303, a determination unit 304, an updating unit 305, and a generation unit 306.

In the DB 301, there are registered various pieces of information and the like regarding each of the apparatuses, such as a type, an apparatus ID, a function, and an owner (private owner or co-owners) of the apparatus. Since the apparatuses have respective different functions (providable functions), the registered pieces of Information also differ depending on the apparatuses. For example, a kotatsu has functions of power ON and OFF, and the like, while a BD recorder has functions of power ON and OFF, reproduction, fast-forward, recording, reservation, and the like.

In addition, in the DB 301, as illustrated in FIG. 8, for each of the apparatuses, there are registered a type, an apparatus ID, and pieces of information regarding security conditions (authentication of an operator, restriction on reliability of a communication network, restriction on tamper resistance of hardware) necessary to operate a corresponding apparatus. FIG. 8 is a table of operation conditions in operating apparatuses by the remote control application registered in the DB 301. Here, since the apparatuses have different security conditions, registered pieces of information are different depending on the apparatuses. In other words, the operation conditions in FIG. 8 show the followings. For example, according to the operation conditions, an apparatus having a heating function, such as a kotatsu, is allowed to be operated by the remote control application of the information terminal 101, only when all of the three kinds of authentication and restriction are satisfied, in other words, only when the operator is successfully authenticated, the established communication network has a high reliability, and the hardware has tamper resistance (in other words, the hardware security module is embedded). In other words, according to the operation conditions, any apparatus not having a heating function, such as a BD recorder, is allowed to be operated by the remote control application of the information terminal 101 if the operator is authenticated, regardless of a reliability of a established communication network or tamper resistance of hardware.

The specifying unit 302 specifies, based on a device ID, a holder (operator) of the information terminal 101 (smartphone) that has issued a processing request.

The determination unit 304 determines, based on current position information of the operator and registered position information of the home, whether the information terminal 101 (smartphone) that has issued the processing request is in the home or outside the home.

The transmission unit 303 transmits an interface corresponding to an attribute of the specified holder (operator), the current position of the information terminal 101 (smartphone), an attribute of an apparatus to be controlled, and a function of the apparatus. In short, the transmission unit 303 can provide an interface according to the situation of the control unit 201 of the information terminal 101.

### 1.4 Operations of Remote Control System

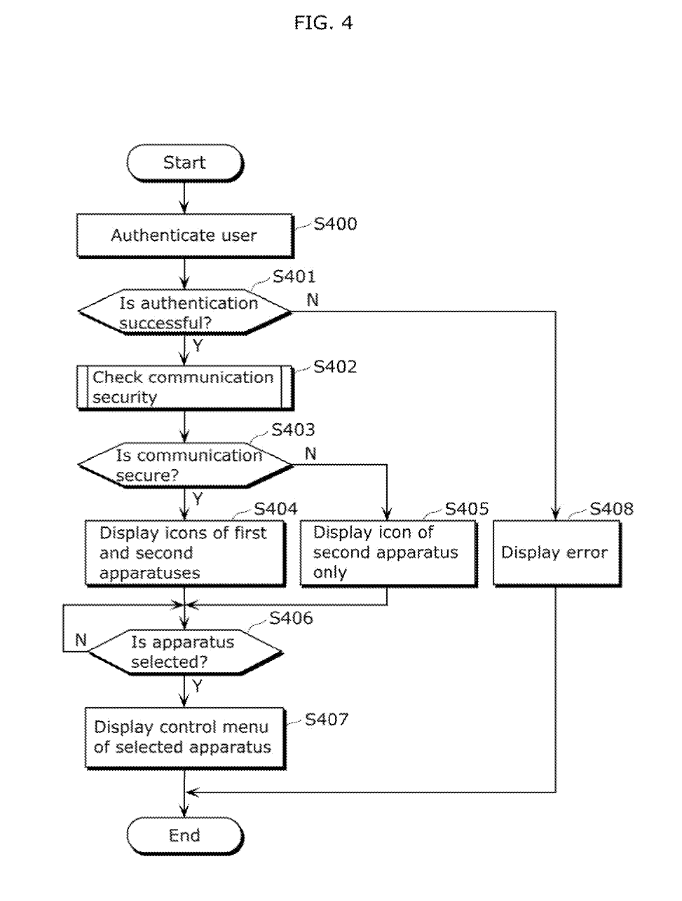

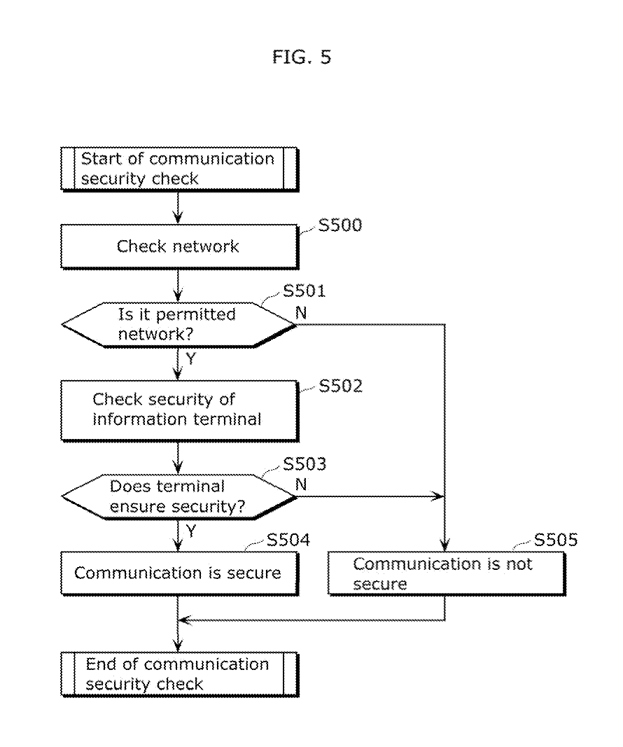

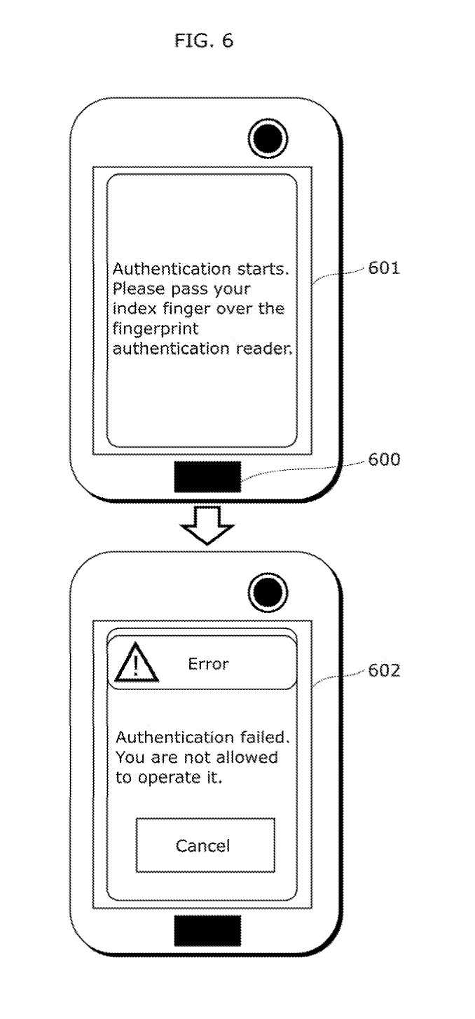

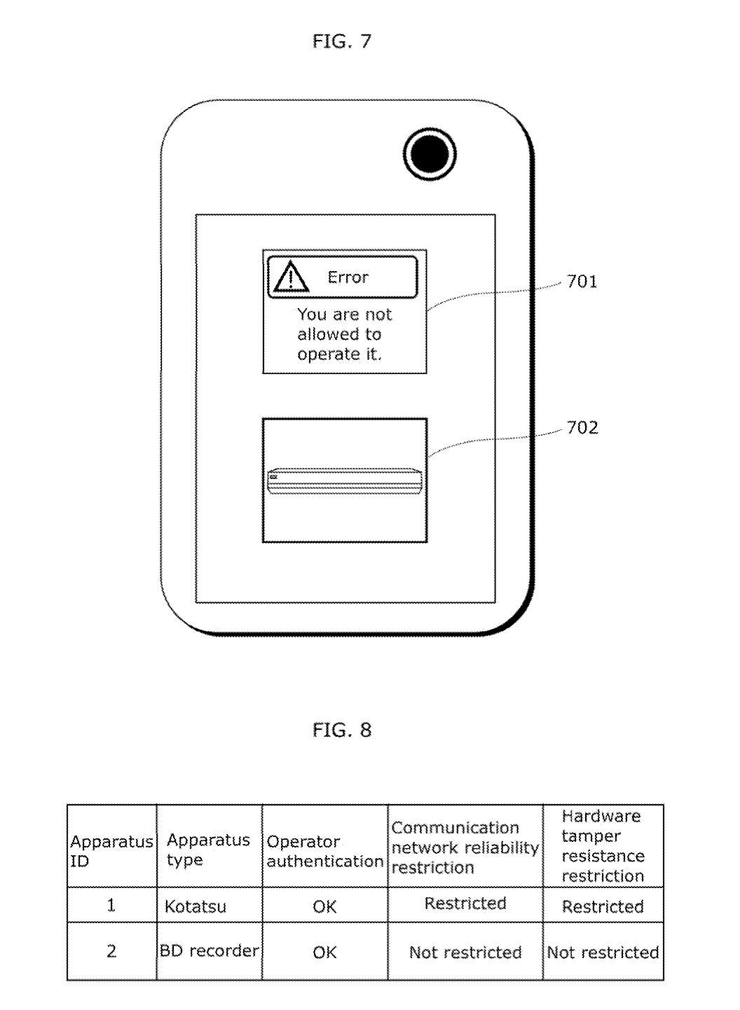

FIG. 4 is a flowchart of processing performed in the remote control system according to Embodiment. FIG. 5 is a flowchart of check processing performed in the remote control system according to Embodiment. Each of FIGS. 6 and 7 is a diagram illustrating an example of an operation screen of a smartphone in the remote control system according to Embodiment.

The information terminal 101 is a terminal having a function of performing remote control on the first apparatus 105b and the second apparatus 105c in the home network 105. The function of the information terminal 101 for serving as a remote controller is provided by the remote control application installed in the information terminal 101.

First, the user starts the remote control application in the information terminal 101. Here, when the remote control application (authentication unit 204) is started, it is determined whether or not the user who has started the remote control application has authority to control the information terminal 101 (authentication processing) (S400). In the authentication processing, in more detail, as illustrated in (a) in FIG. 6, the authentication unit 204 causes the display unit 205 of the information terminal 101 to display an authentication screen 601 for fingerprint authentication, so as to prompt the user to pass a user's index finger or the like over a fingerprint authentication reader 400. In the information terminal 101, the authentication unit 204 determines whether or not a fingerprint that is registered by the user matches a fingerprint detected by the fingerprint authentication reader 400, thereby performing the authentication processing. In other words, if it is determined that the registered fingerprint matches the fingerprint detected by the fingerprint authentication reader 400, the authentication unit 204 determines the authentication using the fingerprint authentication as successful (the user has authority to control the information terminal 101). Otherwise, the authentication unit 204 determines the authentication using the fingerprint authentication as failure (the user does not have authority to control the information terminal 101).

Next, the control unit 201 determines whether or not the authentication processing by the fingerprint authentication is successful (S401).

If the authentication processing by the fingerprint authentication is successful (Y at S401), then the remote control application (control unit 201) permits the user to use the information terminal 101, and performs check processing for checking whether or not communication currently performed via the network 103 is secure (S402).

The check processing (S402) described in more detail with reference to FIG. 5.

In the check processing at Step S402, first, the control unit 201 checks the communication currently performed by the information terminal 101 with a network (S500). More specifically, if the information terminal 101 is connected to the first network 103a that is a paid communication network, such as a mobile telephone line, which is subscribed from a communication company, the control unit 201 determines that the communication currently performed by the information terminal 101 uses a communication network having a high reliability (permitted network). On the other hand, if the information terminal 101 is connected to the second network 103b that is a free communication network, such as a public wireless LAN, the control, unit 201 determines that the currently performed communication has a communication network having a low reliability (non-permitted network).

Next, the control unit 201 determines whether or not the network with which the information terminal 101 is performing the communication is a permitted communication network (S501),

If the network is a permitted network (Y at S501), then the control unit 201 checks security of the information terminal 101 (S502). In other words, the remote control application (control unit 201) checks whether or not the information terminal 101 ensures security. More specifically, if the network 103 with which the information terminal 101 is performing the communication is a communication network has a high reliability (V at S501), then the remote control application (control unit 201) performs communication for operating the apparatuses. Here, the communication unit 200 performs secured communication by for example, Secure Socket Layer (SSL), so that information to be exchanged can be encrypted. Key information used in the encryption is stored in the security unit 203 in the smartphone. Since the region storing such key information would be different depending on structures of used smartphones, the remote control application (control unit 201) confirms whether or not the information terminal 101 has the security unit 203. In other words, the control unit 201 determines whether or not the communication currently performed by the information terminal 101 is performed by using the hardware security module.

Then, the control unit 201. determines whether or not the information terminal 101 ensures security (S503).

If it is determined that the using information terminal 101 is embedded with the security unit 203 (in other words, the information terminal 101 ensures security) (Y at S503), then the control unit 201 determines that the communication currently performed by the information terminal 101 is secure (S504). In other words, in the case of at Step S503, the control unit 201 determines that the communication currently performed by the information terminal 101 uses a communication network having a high reliability and that the key information is protected by hardware. Therefore, the control unit 201 eventually determines that the communication currently performed by the information terminal 101 is secure, and ends he check processing.

On the other hand, if it is determined at Step S501 that the network 103 with which the information terminal 101 is performing the communication is not a permitted communication network (N at S501) or if it is determined that the using information terminal 101 is not embedded with the security unit 203 (in other words, the information terminal 101 does not ensure security) (N at S503), then the control unit 201 eventually determines that the communication currently performed by the information terminal 101 is not secure (S505), and ends the check processing.

By referring back to FIG. 4, if the check processing at Step S402 is ended, then the control unit 201 determines whether or not the communication currently performed by the information terminal 101 is secure (S403).

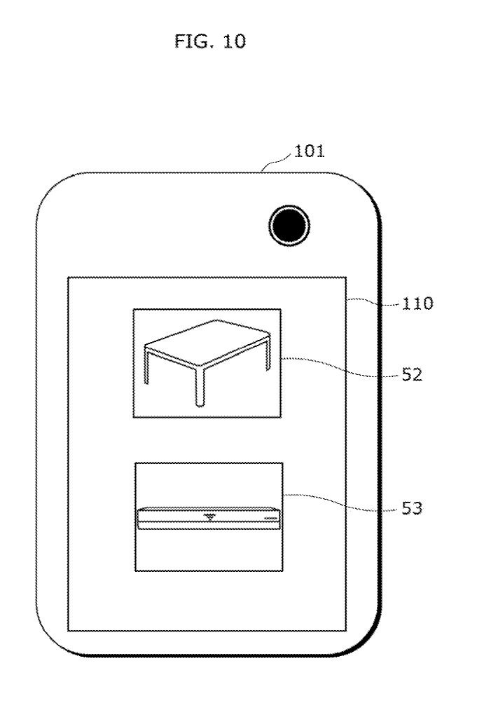

Here, if the control unit 201 determines that the communication currently performed by the information terminal 101 is secure (Y at S403), this means that all operation conditions (see FIG. 8) are satisfied for the first apparatus 105b (kotatsu) and the second apparatus 105c (BD recorder). Therefore, icons of the first apparatus 105b and the second apparatus 105c are displayed on the user interface region of the display unit 205 in a display mode in which the user can select the icons (hereinafter, referred to also as “selectable display mode”) (S404). In other words, if the encryption key information is protected by hardware and communication having a high reliability is established, the remote control application displays icons of both the first apparatus 105b and the second apparatus 105c in a selectable display mode (for example, FIG. 10).

In the check processing, if it is determined that the communication currently performed via the network 103 is not secure (N at S403), this means that the operation conditions for the first apparatus 105b (kotatsu) are not satisfied but the operation conditions for the second apparatus 105c (BD recorder) are satisfied. Therefore, only the icon of the second apparatus 105c is displayed on the user interface region of the display unit 205 in a selectable display mode (S405). In other words, if it is determined at S501 that the communication network has a low reliability (N at S501), or it is determined at S503 that the encryption key information is not protected by hardware (N at S503), an icon 701 is displayed to notify that operation of the first apparatus 105b is not allowed, and an icon 702 of the second apparatus 105c only is displayed in a selectable display state.

Then, the control unit 201 determines whether or not the selectable Icon is selected by user's tapping (S406).

For example, if it is determined that the user taps the icon of the first apparatus 105b (Y at S406), then control menus for operating the first apparatus 105b are displayed (S407). Likewise, if it is determined that the user taps the icon of the second apparatus 105c (Y at S406), then control menus for operating the second apparatus 105c are displayed (S407). Here, even if it is determined that the icon 701 is tapped, the control unit 201 does not perform anything because the icon 701 is not displayed as selectable.

On the other hand, if it is determined at Step S401 that the authentication fails (N at S401), a remote control application screen 602 for notifying the user of that the user does not have authority for operation is displayed on the display unit 205 as illustrated in (b) in FIG. 6 (S408), and the processing is ended.

### 1.5 Example

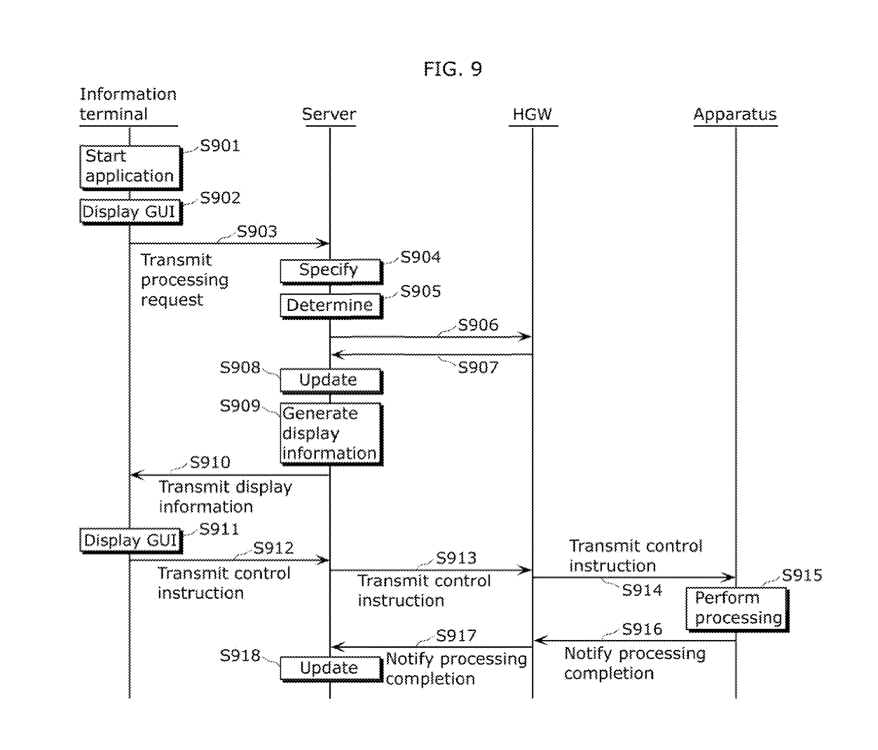

The following describes, as Example, an example of the remote control on an apparatus to be controlled, by the remote control system 100 operating as above, with reference to a time chart illustrated in FIG. 9.

FIG. 9 is a time chart illustrating an example of processing performed by the remote control system according to Example of Embodiment.

Here, a function of the smartphone (information terminal 101) for serving as a remote controller is assumed to be executed by the remote control application installed in the smartphone in the same manner as described previously.

First, an operator (hereinafter, referred to as a “user”) of the smartphone (information terminal 101) starts the remote control application (S901).

Then, the remote control application displays a Graphical User Interface (GUI) of the remote control application on a display screen 110 illustrated in FIG. 10 (S902). In other words, here, by performing Steps S400 to S405 in FIG. 4 as described above, the remote control application GUI is displayed,

FIG. 10 is a diagram illustrating an example of a display screen of the smartphone according to Example of Embodiment. The display screen 110 illustrated in FIG. 10 corresponds to the user interface region of the display unit 205. The user can perform touch inputting on the display screen 110. In the example illustrated in. FIG. 10, the kotatsu and the BD recorder are displayed by icons (icons 52 and 53) as candidates of apparatuses to be controlled. If the kotatsu is to be controlled, the user taps (touch-inputs) the icon 52 of the kotatsu to select the kotatsu as a target apparatus.

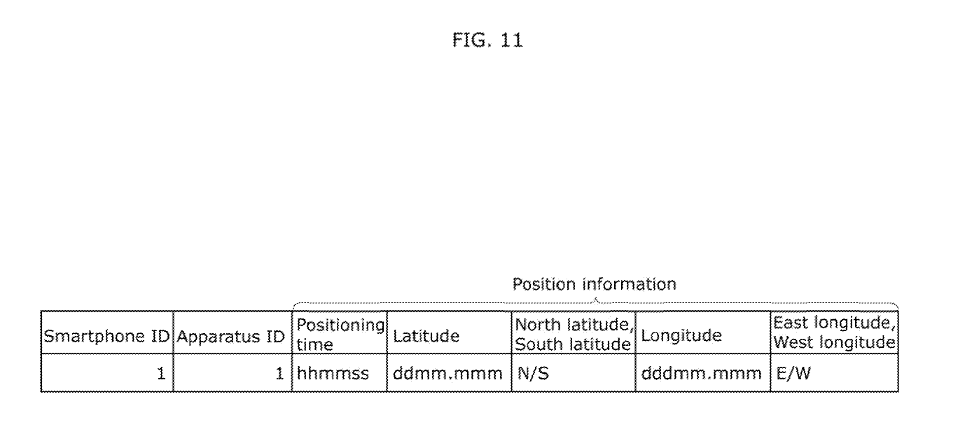

Next, if the kotatsu is selected as a target apparatus, then the remote control application transmits, to the server 104, a processing request regarding the kotatsu together with, for example, pieces of information as illustrated in FIG. 11, such as an ID of the smartphone (information terminal 101), position information of the smartphone (positioning information by GPS), and an apparatus ID of the kotatsu (S903). It is assumed that the smartphone ID and the apparatus ID illustrated in FIG. 11 are previously shared by the server 104 and the remote control application. Here, FIG. 11 is a table indicating details of the information transmitted from the remote control application to the server according to Example of Embodiment. It should be noted that Step S903 is performed by executing Step S406 in FIG. 4.

The position information of the smartphone may include altitude information determined by GPS and the like in addition to the positioning information determined by the GPS. The positioning of the GPS in the position information may be performed regularly, when starting the remote control application, when transmitting to the server 104, or the like, The positioning method of the position information is not limited to GPS, For example, it is also possible to use position information of a base station of the smartphone, or estimate a current position of the smartphone from a move history using an acceleration sensor in the smartphone. It is further possible to determine that the user has left home when the user locks a front door of the home by using the smartphone. In short, there are various methods for estimating (determining) the position information, and any method can be used.

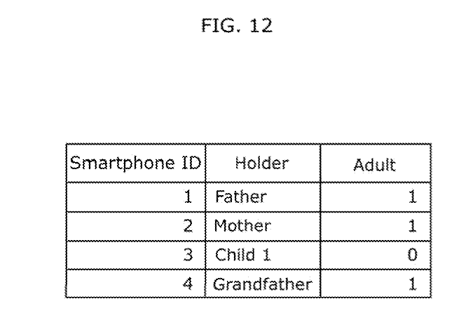

Next, the server 104 performs specifying processing (S904). More specifically, the specifying unit 302 of the server 104 specifies an attribute of the user based on (a) the smartphone ID notified (transmitted) from the remote control application of the smartphone and (b) the user information table as illustrated in FIG. 12. FIG. 12 is an example of the user information table registered in the DB in the server according to Example of Embodiment. More specifically, if the smartphone ID notified from the remote control application (information terminal 101) is “1”, the specifying unit 302 of the server 104 can specify, based on the user information table of FIG. 12 that a holder of the smartphone is a “father” who is an “adult”.

Next, the server 104 performs specifying processing (S905). More specifically, the determination unit 304 of the server 104 determines whether the smartphone that has issued the processing request is in the home or outside the home, based on (a) the current position information of the smartphone which is notified from the remote control application of the smartphone and (b) registered position information of the home.

Here, for example, if a difference between the current position information of the smartphone and the position information of the home is within ±10 m, the determination unit 304 of the server 104 determines that the smartphone is in the home. Otherwise, the determination unit 304 determines that the smartphone is outside the home If the smartphone is connected to a wireless LAN in the home, the determination unit 304 of the server 104 may determine that the smartphone is in the home regardless of the positioning information.

If it is impossible to obtain the positioning information or if the positioning information is obtained but has a low accuracy, the determination unit 304 of the server 104 may determine that the smartphone is outside the home. This is to restrict functions of the smartphone used outside the home in view of security or the like, so as to prevent that the smartphone operates apparatuses from outside of the home even if the smartphone has such a function. In the above cases, the security is enhanced if the smartphone is determined as being outside the home, rather than erroneously determined as being in the home.

Hereinafter, it is assumed that the determination unit 304 of the server 104 has determined at S905 that the smartphone (information terminal 101) which has issued the processing request is in the home.

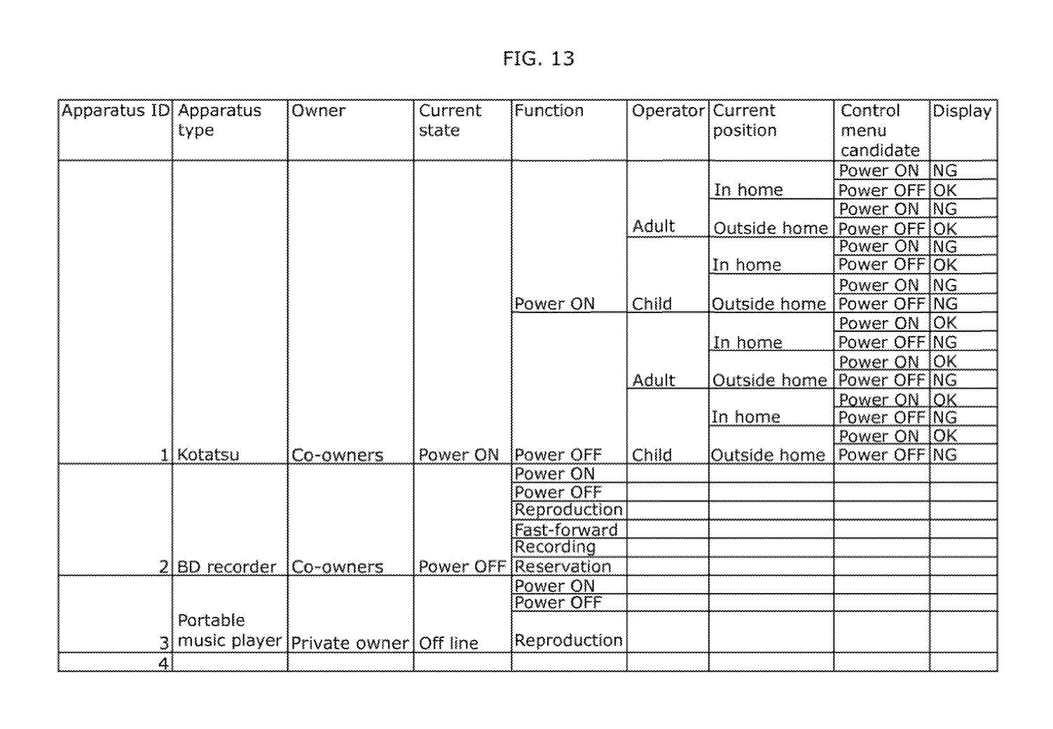

Next, the server 104 performs updating processing for updating information of a current state of the apparatus (S908). More specifically, the updating unit 305 of the server 104 obtains a current state of the apparatus indicated by the apparatus ID notified from the smartphone via communications with the HGW 105a that is detecting real-time changing of the states of the apparatuses (S906 and S907). Therefore, the updating unit 305 of the server 104 updates items (current state of the target apparatus) in the operation history table, for example, as illustrated in FIG. 13 (S908). In Example, at S908, as illustrated in FIG. 13, the item indicating the state of the kotatsu having the apparatus ID of “1” is “powered ON”.

FIG. 13 is an example of the user information table registered in the DB in the server according to Example of Embodiment. In the DB 301 in the server holds, there are registered, as an apparatus information table, pieces of information regarding the apparatuses, for example, as illustrated in FIG. 13. In the apparatus information table illustrated in FIG. 13, an apparatus ID, an apparatus type, an owner, and operable functions of each of the apparatuses have already been registered.

Since the server 104 can obtain a state of each apparatus in real time via communication with the HGW 105a, it is possible to reflect the current state of each apparatus to an item of the state in the operation history table that is registered in the DB 301.

It should also be noted that the server 104 may inquire the apparatus about the state of the apparatus via the HGW 105a every time a processing request is received from the smartphone.

Furthermore, the server 104 stores, as logs, a position of the smartphone, details of the processing request, the state of the apparatus, and the like in the DB 301, to be used as control indexes. Then, the server 104 may analyze the control indexes to determine a display mode of control menus or a user interface of the apparatus.

Next, the server 104 generates display information based on the control indexes (S909). More specifically, the generation unit 306 of the server 104 determines whether each of an ON button and an OFF button as control menus is to be displayed or not to be displayed, based on an attribute of the user, a position of the smartphone, control indexes such as a current state of the kotatsu, and the apparatus information table of FIG. 13. Based on the result of the determination, the server 104 generates display information that indicates a display mode and details of display on the display unit 205 so as to provide the display information to the control unit 201 of the smartphone.

In Example, since the attribute of the user (holder) of the smartphone is an “adult”, the current position of the smartphone is “in home”, and the current state of the kotatsu is “powered ON”, the generation unit 306 of the server 104 determines that the ON button is “not to be displayed” and the OFF button is “to be displayed” as control menus as illustrated in FIG. 13. The generation unit 306 of the server 104 generates display information based on the result of the determination. Although it has been described in Example that the display information is generated by the server 104, the present invention is not limited to the above. It is also possible that the server 104 notifies the determination result to the remote control application, and the remote control application generates the display information based on the notified determination result.

Next, the server 104 (transmission unit 303) notifies (transmits) the generated display information to the remote control application (S910).

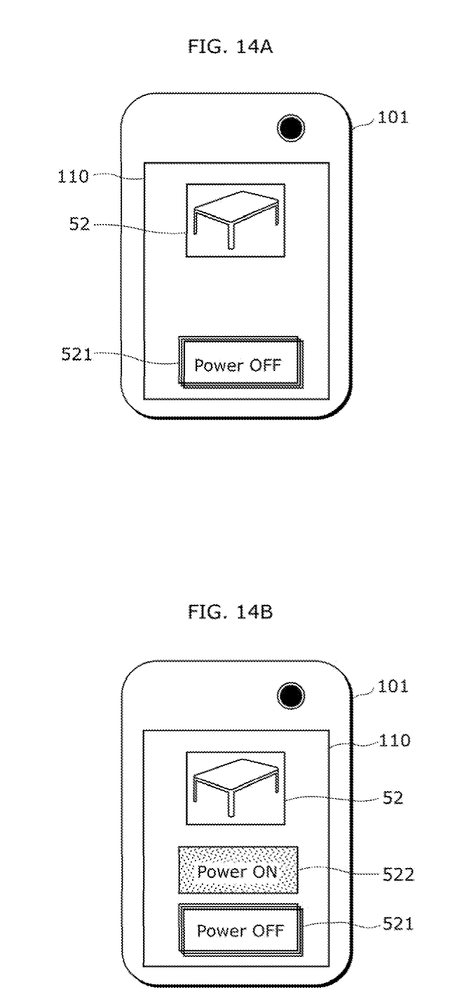

Next, the remote control application displays a User Interface (UI) according to the notified (transmitted) display information (S911). More specifically, based on the transmitted display information, the remote control application (control unit 201) of the smartphone determines details (display details) and a display mode to be displayed on the user interface region of the display unit 205. Then, the remote control application causes the display unit 205 to display the determined display details in the determined display mode (display screen 110) as illustrated in FIG. 14A or FIG. 14B, for example. Each of FIG. 14A and FIG. 14B is a diagram illustrating an example of a display screen of the smartphone according to Example of Embodiment. It should be noted that Step S911 corresponds to Step S407 in FIG. 4.

In Example, as illustrated in FIG. 14A, for example, based on the notified (transmitted) display information, the remote control application does not display the ON button as a control menu as determined at S909, and displays only the OFF button (power OFF button 521) as a control menu on the display screen 110 displayed on the display unit 205. It should be noted that, as illustrated in FIG. 14B, the remote control application may perform grayout display for the ON button (power ON button 522) that has been determined not to be displayed, thereby showing that the ON button is not selectable as a control menu.

Next, the user of the smartphone taps (touch-inputs) a button displayed on the display screen 110 (user interface region) to instruct execution of processing corresponding to the button. Then, the remote control application notifies (transmits), to the server 104, a control signal indicating the instruction of the execution of the processing (S912). In Example, the control signal instructs execution of powering OFF a target apparatus.

Next, the server 104 instructs, via the HGW 105a, target apparatus to perform the processing indicated by the control signal notified from the remote control application (S913, S914). In Example, since the target apparatus is the kotatsu, the server 104 instructs the kotatsu to perform the processing indicated by the control signal to be powered OFF (execution instruction).

In receiving the control signal, the target apparatus performs the instructed processing (5915), and notifies completion of the processing to the server 104 via the HGW 105a (S916, S917). In Example, the kotatsu is powered OFF after receiving the control signal, and notifies completion of the processing to the server 104 via the HGW 105a. Although it has been described that the target apparatus receives the control signal, the present invention is not limited to the above. It is also possible that the target apparatus receives only a signal for requesting the execution of the processing, from the server based on the control signal. In this case, the target apparatus may perform the processing based on the received signal.

Finally, the server 104 is notified from the target apparatus via the HGW 105a that the processing has been completed, and updates information indicating the current state of the target apparatus (S918). In Example, the updating unit 305 of the server 104 is notified from the kotatsu via the HGW 105a that the processing has been completed, and updates the item “state” in the apparatus state table of FIG. 13 to “powered OFF”.

### 1.6 Effects

As described above, in Embodiment, individual authentication is performed to securely operating the apparatuses. As a result, it is possible to restrict who can operate a target smartphone, so as to prevent that a different person pretends to be a user of the smartphone to operate apparatuses.

Furthermore, in Embodiment, if operation on a target apparatus is performed by communication via a free network such as a public wireless LAN, it is determined that the currently performed communication is not secure. Therefore, the operation on the target apparatus is restricted. As a result, for example, even if unauthorized access by hacking or the like occurs, it is possible to restrict operation on apparatuses having a heating function, such as a kotatsu.

Moreover, in Embodiment, if the information terminal 101 does not have a hardware security module such as a security chip due to tamper resistance and is therefore incapable of protecting an encryption key as hardware, operation of the information terminal 101 on apparatuses is restricted. As a result, even if the encryption key in the information terminal 101 is maliciously read out, it is possible to restrict operation on apparatuses having a heating function, such as a kotatsu.

### 1.7 Variations

It should be noted that it has been described in Embodiment that the authentication processing uses fingerprint authentication, but the present invention is not limited to the above. It is also possible to employ individual recognition using image such as a face, or speaker recognition using voice.

It should also be noted that it has been described in Embodiment that when authentication is failed, a message “Your are not allowed to operate it.” is displayed on the screen, but the present invention is not limited to the above. For example, if a user who is not a holder of a smartphone but a family of the holder fails authentication for the smartphone, it is also possible to grayout-display on an icon of a certain apparatus A but allow the user to operate a different apparatus B. It is also possible that, if authentication is failed, email notifying the authentication failure is transmitted to smartphones owned by family members at the same time.

It should further be noted that it has been described in Embodiment that the first network 103a is a paid network (for example, mobile communication network) and the second network 103b is a free network (for example, public wireless LAN), but the present invention is not limited to the above. The first network 103a may be a local network such as a Wide Area Network (WAN), and the second network 103b may be a global network such as the Internet. Furthermore, regarding a communication line, it is possible to determine a line that is often disconnected and has a low reliability as a network having a low reliability for which operation restriction is necessary. Moreover, for a communication line, it is possible that communication networks having a relatively high communication speed, such as Wireless Fidelity (Wi-Fi), WIMAX, LIE, and 3G, are distinguished from communication networks having a relatively low communication speed, such as communication networks using Bluetoot®, ZigBee, NFC, and infrared ray. Therefore, it is possible to determine a communication network having a low communication speed as a network having a low reliability for which operation restriction is necessary.

It should still further be noted that it has been described in Embodiment that if it is determined that a communication network has a low reliability (N at S501) or it is determined that encryption key information is not protected by hardware (N at S503), the icon of the first apparatus 105b is not displayed, but the present invention is not limited to the above. It is also possible that an icon of an apparatus for which operation is restricted is grayout-displayed so that the apparatus is not allowed to be operated even if the grayout icon is tapped.

It should still further be noted that it has been described in Embodiment that, in the check processing at Step S402, if it is determined that a network established by the information terminal 101 is not a permitted network (N at S501), the control unit 201 determines that the communication is not secure (S505), but the present invention is not limited to the above. For example, it is also possible that if it is determined that the network established by the information terminal 101 is not a permitted network (in other words, if it is determined that the information terminal 101 is connected to the second network 103b), the control unit 201 causes display of a dialog for prompting the user to confirm whether or not to switch the network to a permitted network (namely, first network 103a). Furthermore, if an input indicating that the network is to be switched is received from the user on the dialog, the control unit 201 may switch the second network 103b to the first network 103a.

It should still further be noted that it has been described in Embodiment that, in the check processing at S402, after the determination as to whether or not the network established by the information terminal 101 is a permitted network (S501), if the determination at Step S501 is “Y”, the determination as to whether or not the information terminal 101 ensures security (S503), but the order of the determinations may be reversed. In other words, it is also possible that the control unit 201 determines that communication currently performed by the information terminal 101 is not secure under only if the information terminal 101 does not ensure security.

Although the integrated remote control User Interface (UI) cooperated with home appliances according to the aspect of the present invention, such as a controller, has been described based on Embodiment, the present invention is not limited to Embodiment. Those skilled in the art will be readily appreciate that various modifications of Embodiment and various combinations of the constituent elements in different embodiments are possible without materially departing from the novel teachings and advantages of the present invention. Accordingly, all such modifications and combinations are intended to be included within the scope of the present invention.

It should be noted that, in the above-described embodiment, each of the constituent elements may be implemented into a dedicated hardware or implemented by executing a software program suitable for the constituent element. Each of the constituent elements may be implemented when a program execution unit such as a Central Processing Unit (CPU) or a processor reads a software program recorded on a recording medium such as a hard disk or a semiconductor memory and executes the readout software program.

### INDUSTRIAL APPLICABILITY

The present invention can be used in a control method of a controller system, and especially in a control method using a mobile information terminal or the like having an integrated remote control UI or a remote control function for cooperating with home appliances to perform remote control on apparatuses having a risk of fire.

### REFERENCE SIGNS LIST

100 remote control system

101, 102 information terminal

103 network

103a first network

103b second network

103c Internet

104 server

105 home network.

105a HGW

105b first apparatus

105c second apparatus

110 display screen

200 communication unit

201 control unit

202 storage unit

203 security unit

204 authentication unit

205 display unit

301 DB

302 specifying unit

303 transmission unit

304 determination unit

305 updating unit

306 generation unit

400 fingerprint authentication reader

521 power OFF button

522 power ON button

601 authentication screen

602 remote control application screen

701, 702 icon

1. A control method used in a remote control system including a plurality of apparatuses and an information terminal that controls at least one of the apparatuses via a network, the control method comprising:
determining whether or not communication currently performed by the information terminal via the network is secure;
displaying, for each of the apparatuses, an icon for displaying one or more control menus corresponding to a corresponding apparatus of the apparatuses, on a user interface region of a display unit in the information terminal in a display mode determined according to the security of the communication determined in the determining;
displaying, on the user interface region in the information terminal, the one or more control menus for controlling the corresponding apparatus, if the icon is selected;
generating a control signal for causing the corresponding apparatus to perform an operation according to control corresponding to a first control menu, if the first control menu is selected from the one or more control menus displayed on the information terminal; and
transmitting the control signal to the corresponding apparatus via the network.

2. The control method according to claim 1,
wherein in the displaying of the icon,
if the corresponding apparatus has a heating function, the display mode of the icon corresponding to the corresponding apparatus is determined according to whether the network connected to the information terminal is a first network or a second network that has a lower reliability than a reliability of the first network.

3. The control method according to claim 2,
wherein in the displaying of the icon,
if the corresponding apparatus has a heating function and the network connected to the information terminal is the second network, the display mode of the icon corresponding to the corresponding apparatus is a display mode in which the icon is not selectable.

4. The control method according to claim 2,
wherein the first network is a paid network, and
the second network is a free network.

5. The control method according to claim 1,
wherein in the displaying of the icon,
if the corresponding apparatus has a heating function, the display mode of the icon corresponding to the corresponding apparatus is determined according to whether or not the communication currently performed by the information terminal is performed using a hardware security module.

6. The control method according to claim 5,
wherein in the displaying of the icon,
if the corresponding apparatus has a heating function and the information terminal is performing the communication without using the hardware security module, the icon corresponding to the corresponding apparatus is displayed in the display mode in which the icon is not selectable.

7. The control method according to claim 1, further comprising
determining whether or not an operator operating the information terminal is a predetermined operator who is registered,
wherein in the displaying of the icon,
if it is determined that the operator is the predetermined operator, the icon corresponding to the each of the apparatuses is displayed on the user interface region, and
if it is determined that the operator is not the predetermined operator, an error display is displayed on the user interface region.
